(19) United States
(12) Patent Application Publication
(10) Pub. No.: US 2015/0269232 A1
(43) Pub. Date: Sep. 24, 2015

(54) INFORMATION PROCESSING APPARATUS, CONTROL METHOD, AND PROGRAM

(71) Applicant: SONY CORPORATION, TOKYO (JP)

(72) Inventors: TOMOHIRO TSUNODA, TOKYO (JP); KAZUKI YOSHIYAMA, KANAGAWA (JP); RYO NAKAHASHI, TOKYO (JP); MASANORI MIYAHARA, TOKYO (JP)

(21) Appl. No.: 14/658,474

(22) Filed: Mar. 16, 2015

(30) Foreign Application Priority Data
Mar. 24, 2014 (JP) 2014-060576

(51) Int. Cl. G06F 17/30

(52) U.S. Cl. CPC G06F 17/30554

(57) ABSTRACT

There is provided an information processing apparatus including an obtaining unit configured to obtain one or more other information elements corresponding to one information element based on a degree of association between the one information element and the other information elements, an extraction unit configured to extract a description of a type of association between the one information element and the obtained other information elements, and a presentation control unit configured to perform control in a manner that the one information element, the other information elements, the type of association, and the description of the type of association are presented.

### CROSS REFERENCE TO RELATED APPLICATIONS

This application claims the benefit of Japanese Priority Patent Application JP 2014-060576 filed Mar. 24, 2014, the entire contents of which are incorporated herein by reference.

### BACKGROUND

The present disclosure relates to an information processing apparatus, a control method, and a program.

In recent years, as the information communication technology has been developed, various types of information, such as music, videos, electronic books, news articles, product information, and event information, are provided to users via a network. Major approaches for an individual user to find out information matching the user from such vast information may include an approach where a user searches by him/herself and an approach where a system recommends information appropriate for the user.

In the approach where a system recommends information appropriate for the user, user's preference is often scored in accordance with an action by the user, such as information browsing and content purchase, and the information relevant to the user's preference is recommended. For example, while a certain product is browsed on a web page, information on a product or a product that is browsed or purchased by another user that has browsed the same product (has a close preference score) is recommended. While a certain product is browsed, information on the product that the user browsed until just before is sometimes recommended.

Related to the technique to recommend information appropriate for a user, JP 2011-138197A, for example, discloses that association of a plurality of information items is evaluated from a variety of perspectives, and when one information item is recommended corresponding to another information item, the perspective of joining these information items is also presented.

### SUMMARY

However, the perspectives to be presented in JP 2011-138197A are indicated directly only by a word, so that the reason for joining has not been easily perceived by the user.

It is desired to propose an information processing apparatus, a control method, and a program that are capable of presenting a type of association, which is a variety of perspectives joining an information item with another information item, together with a reason explanation.

According to an embodiment of the present disclosure, there is provided an information processing apparatus including an obtaining unit configured to obtain one or more other information elements corresponding to one information element based on a degree of association between the one information element and the other information elements, an extraction unit configured to extract a description of a type of association between the one information element and the obtained other information elements, and a presentation control unit configured to perform control in a manner that the one information element, the other information elements, the type of association, and the description of the type of association are presented.

According to another embodiment of the present disclosure, there is provided a control method including obtaining one or more other information elements corresponding to one information element based on a degree of association between the one information element and the other information elements, extracting a description of a type of association between the one information element and the obtained other information elements, and performing control in a manner that the one information element, the other information elements, the type of association, and the description of the type of association are presented.

According to still another embodiment of the present disclosure, there is provided a program for causing a computer to function as an obtaining unit configured to obtain one or more other information elements corresponding to one information element based on a degree of association between the one information element and the other information elements, an extraction unit configured to extract a description of a type of association between the one information element and the obtained other information elements, and a presentation control unit configured to perform control in a manner that the one information element, the other information elements, the type of association, and the description of the type of association are presented.

As just been described, according to an embodiment of the present disclosure, it is possible to present a type of association, which is a variety of perspectives joining an information item with another information item, together with a reason explanation.

Note that the effects described above are not necessarily limited, and along with or instead of the effects, any effect that is desired to be introduced in the present specification or other effects that can be expected from the present specification may be exhibited.

### BRIEF DESCRIPTION OF THE DRAWINGS

FIG. 1 is a diagram illustrating an outline of an event specific communication system according to an embodiment of the present disclosure;

FIG. 2 is a diagram illustrating a display screen example by a comparative example of information recommendation;

FIG. 3 is a block diagram illustrating an example of a configuration of an information processing apparatus according to an embodiment;

FIG. 4 is a diagram illustrating a first logic based on outward reference relationship;

FIG. 5 is a diagram illustrating a second logic based on inward reference relationship;

FIG. 6 is a diagram illustrating an example of unexpectedness score calculation in each web page;

FIG. 7 is a diagram illustrating an example of a linkage score by link (reference relationship) analysis of each node;

FIG. 8 is a block diagram illustrating an example of a configuration of a user terminal according to an embodiment;

FIG. 9 is a diagram illustrating a first display example of an information element screen;

FIG. 10 is a diagram illustrating an example of an information element screen included in a book sales site;

FIG. 11 is a diagram illustrating an example of another information element screen included in a book sales site;

FIG. 12 is a sequence diagram illustrating operation process of an information processing apparatus included in an information processing system according to an embodiment;

FIG. 13 is a diagram illustrating an outline of integration with collaborative filtering;

FIG. 14 is a diagram illustrating an outline of calculation of collaborative filtering; and

FIG. 15 is a diagram illustrating integration of linkage of each node by link analysis with linkage of each node by collaborative filtering.

### DETAILED DESCRIPTION OF THE EMBODIMENTS

Hereinafter, preferred embodiments of the present disclosure will be described in detail with reference to the attached drawings. In this specification and the drawings, structural elements that have substantially the same function and structure are denoted with the same reference numerals, and repeated explanation of these structural elements is omitted.

The description will be provided in the following order.

1. Outline of information processing system according to embodiment of the present disclosure
2. Configuration example of information processing apparatus

2-1. Association node obtaining unit

2-2. Association reason extraction unit

2-3. Screen control unit

3. Configuration example of user terminal
4. Operation process
5. Application examples

### 6. Conclusion

### 1. OUTLINE OF INFORMATION PROCESSING SYSTEM ACCORDING TO EMBODIMENT OF THE PRESENT DISCLOSURE

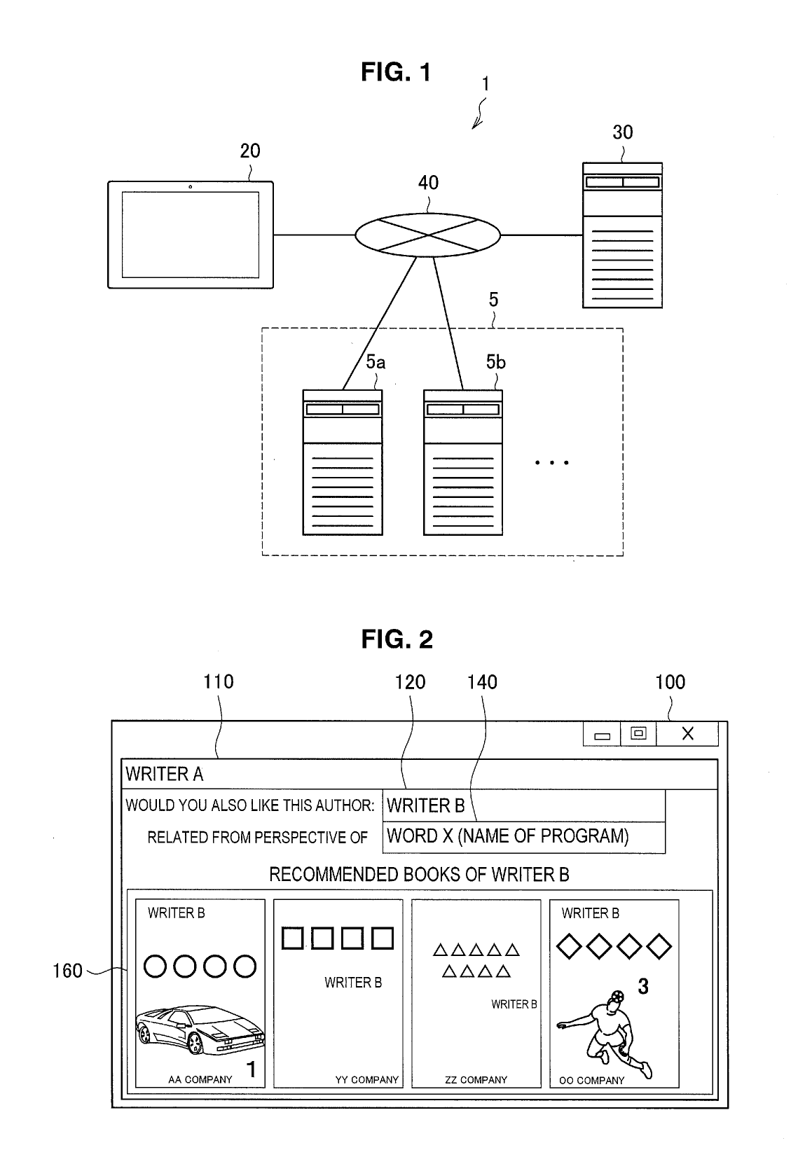

Firstly, using FIG. 1, a description is given to an information processing system to which an embodiment of the present disclosure may be applied. FIG. 1 is a schematic diagram illustrating an outline of an information processing system 1 according to an embodiment of the present disclosure. Referring to FIG. 1, the information processing system 1 includes a user terminal 20 and an information processing apparatus 30. The information processing apparatus 30 is connected to the user terminal 20 via a communication network 40. The communication network 40 is a communication network to connect the information processing apparatus 30 and the user terminal 20. The communication network 40 may also be an arbitrary communication network, such as the internet, an internet protocol-virtual private network (IP-VPN), a dedicated line, a local area network (LAN), and a wide area network (WAN), for example. It does not matter whether the communication network is wired or wireless. The information processing apparatus 30 is capable of accessing an information source 5 including one or more servers 5a, 5b, . . . via the communication network 40.

The servers 5a and 5b are server devices that are accessible from the information processing apparatus 30 via the communication network 40, respectively. Each server may also be, for example, a web server to send a web page in accordance with a request from the information processing apparatus 30. Alternatively, each server may also be, for example, a content server, a database server, or a log server.

The information processing apparatus 30 is a device to obtain a set of information from the server 5a or 5b and extract the type of association between information elements and the reason explanation using the set of information. The information element subject to extraction of the type of association by the information processing apparatus 30 is defined in accordance with the purpose of the service provided by the information processing apparatus 30. For example, for the purpose of providing books, a name of writer, a name of original author, a title, a name of publisher, and the like may also be defined as the information elements. For the purpose of guiding television programs by digital broadcasting, a name of program, a name of cast, and the like may also be defined as the information elements. For the purpose of providing a music content, a name of artist, a title of music, and the like may also be defined as the information elements.

As the set of information utilized by the information processing apparatus 30, a set of information having reference relationship with each other is selected. For example, in a group of web pages provided from a web server, reference relationship is given by a link between web pages. The information processing apparatus 30 extracts the type of association between information elements and the reason explanation based on such reference relationship in a set of information. Further, in the present embodiment, the information processing apparatus 30 provides a graphical user interface (GUI) to present the corresponding information element, the type of association, and the reason explanation to a user. The information processing apparatus 30 may also be, for example, a server as illustrated in FIG. 1. Alternatively, the information processing apparatus 30 may also be a general purpose computer and the like.

The user terminal 20 is a device to be operated by a user and has a display on which the GUI provided by the information processing apparatus 30 is displayed. Accordingly, it is possible that a user browses an information element while being assisted by navigation by the information processing apparatus 30 using the user terminal 20. Further, the user terminal 20 displays the information element recommended from the information processing apparatus 30 on a display. The user terminal 20 may be an arbitrary terminal device, such as a tablet terminal, a smartphone, a personal computer (PC), a mobile phone, a personal digital assistant (PDA), a head mounted display (HMD), a wristwatch terminal, a wearable or game terminal, and the like, for example.

(Background)

Here, although recommendation techniques in the past are capable of evaluating a degree of association of a plurality of information items from a variety of perspectives and recommending an unexpected information item associated with another information item, the perspectives to join these information items are directly indicated only by a word and thus the reason for joining has not easily been perceived by a user. A description is given below to a comparative example, referring to FIG. 2, in which the perspective to join a plurality of information items is directly indicated only by a word.

FIG. 2 is a diagram illustrating a display screen example by a comparative example of information recommendation. As illustrated in FIG. 2, a recommendation screen 100 by a comparative example includes a display area 110 to display one information element, a display area 120 to display another information element associated with the one information element, and a display area 140 to display the perspective (type of association) to join these information items. FIG. 2 illustrates that a writer A and a writer B are related from the perspective of “word X (name of program)” and recommended books of the writer B are displayed in a display region 160.

It is thus possible that the user understands association between the writer A and the writer B with “word X (name of program)” and further browses book information of the writer B. However, it is not possible to sufficiently understand how “word X (name of program)” joins the writer A with the writer B only by indicating the perspective directly by a word.

The present embodiment proposes an information processing system that is capable of causing a user to sufficiently understand joining of an information item with another information item by presenting a type of association, which is a variety of perspectives joining the information item with the other information item, together with a reason explanation.

### 2. CONFIGURATION EXAMPLE OF INFORMATION PROCESSING APPARATUS

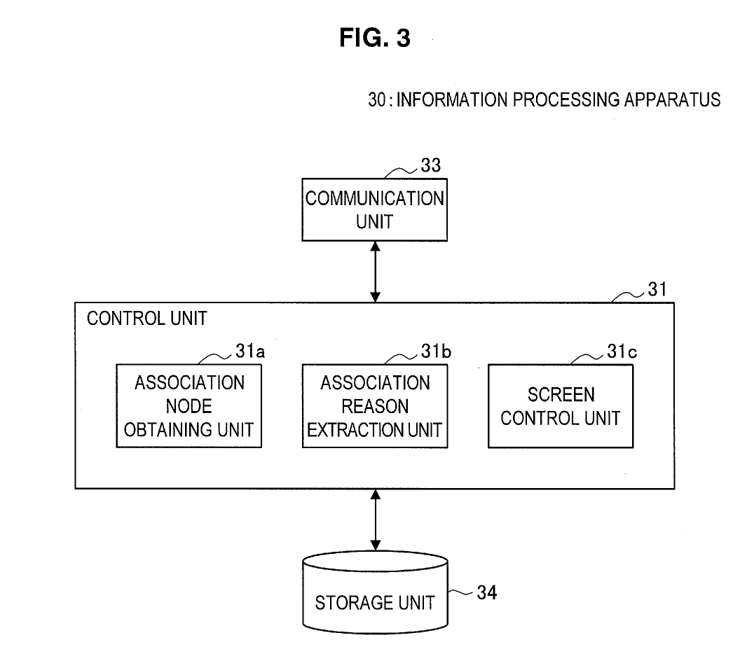

Next, a description is given to an example of a configuration of the information processing apparatus 30 according to the present embodiment. FIG. 3 is a block diagram illustrating an example of a configuration of the information processing apparatus 30. Referring to FIG. 3, the information processing apparatus 30 is provided with a control unit 31, a communication unit 33, and a storage unit 34.

The control unit 31 is configured by a microcomputer provided with, for example, a central processing unit (CPU), a read only memory (ROM), a random access memory (RAM), a non-volatile memory, and an interface unit and controls each component of the information processing apparatus 30. The control unit 31 according to the present embodiment functions as, as illustrated in FIG. 3, an association node obtaining unit 31a, an association reason extraction unit 31b, and a screen control unit 31c. The control unit 31 obtains another information element (may also be referred to as a node) associated with one information element by these functions, extracts a description of the type of association (association reason), and sends a screen presenting the one information element and the other information element together with the association reason to the user terminal 20. Details of each function are described later.

The communication unit 33 is connected to the communication network 40 and capable of accessing the user terminal 20 and the information source 5 via the communication network 40. For example, the communication unit 33 obtains a set of information having reference relationship with each other from the information source 5. The set of information to be obtained may be the group of web pages linked to each other as described above and the like. The communication unit 33 outputs the set of information thus obtained to the control unit 31. The communication unit 33 is also connected to the user terminal 20 to send an information element display screen generated in the screen control unit 31c.

The storage unit 34 stores a program to perform various processes by the control unit 31 using a storage medium, such as a hard disk and a semiconductor memory. The storage unit 34 also stores information elements (nodes) and a degree of association of each information element obtained from the set of information by the association node obtaining unit 31a of the control unit 31, types of association and the reason explanation extracted by the association reason extraction unit 31b, and the like.

The configuration of the information processing apparatus 30 according to the present embodiment has been described above in general. Subsequently, a detailed description is given to each function of the control unit 31 included in the information processing apparatus 30.

<2-1. Association Node Obtaining Unit>

The association node obtaining unit 31a obtains one or more other information elements corresponding to one information element based on the association between the one information element and another information element. The degree of association between the one information element and the other information element is determined based on reference relationship of a first set of information corresponding to the one information element and a second set of information corresponding to the other information element with a third set of information from which the type of association (perspective) is extracted out of the sets of information obtained from the information source 5 that is accessible via the communication network 40.

(Degree of Association)

As a specific method of calculating a degree of association, a method disclosed in JP 2011-138197A above, for example, is used. That is, the association node obtaining unit 31a firstly functions as a classification unit to classify (divide into classes) individual information items included in the set of information obtained by the communication unit 33 into first class information corresponding to an information element defined by information element data and second class information other than the first class information. Hereinafter, the first class is referred to as a node class and the second class is referred to as an association class.

The node class is a class for information corresponding to an information element defined by the information element data. For example, when the information processing apparatus 30 provides a service for providing books, information describing a name of writer, a name of original author, a title, a name of publisher, and the like may be information on the node class. In contrast, the association class is a class for information other than information on the node class. That is, for example, information describing a matter other than a name of writer, a name of original author, a title, a name of publisher, and the like may be information on the association class. The information on the association class represents association between information elements respectively corresponding to information on two or more node classes by having reference relationship with the information on the node classes.

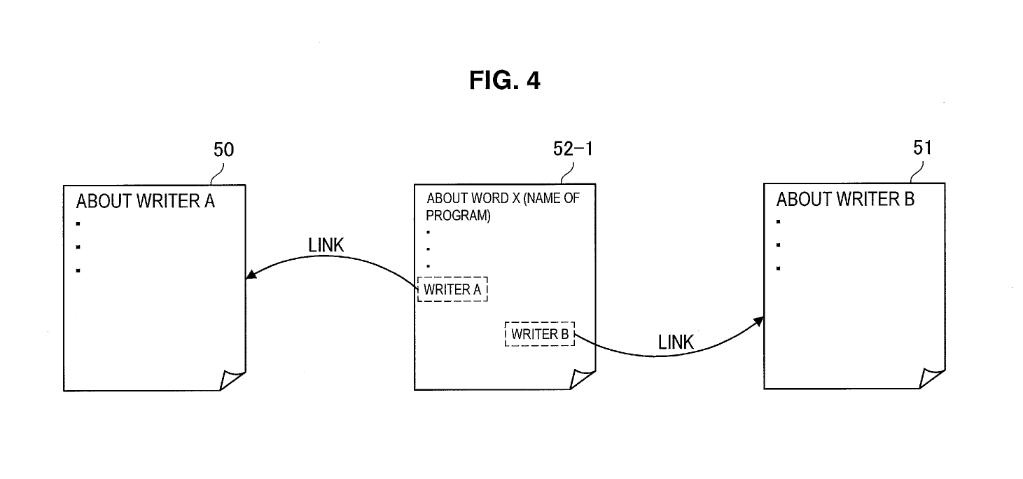

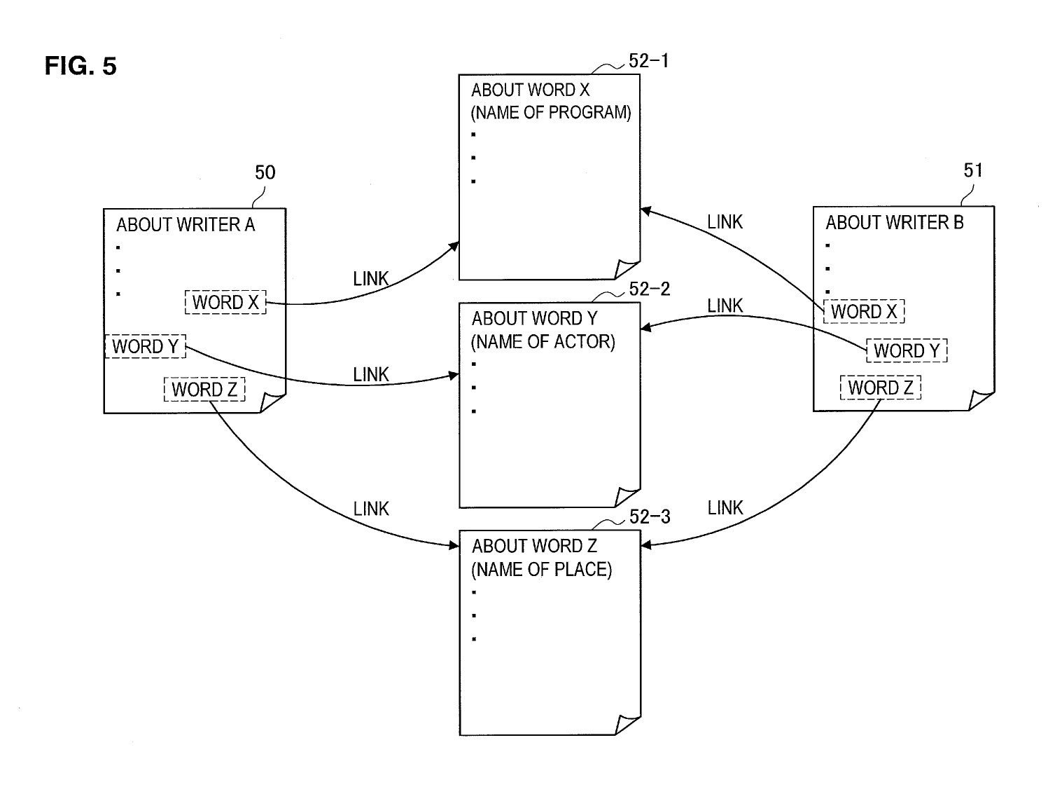

For example, each web page included in a set of information has an index related to content described in the web page. The index of each web page is checked with the “information element” defined by the information element data to classify a web page having an index relevant to the “information element” into the node class and a web page having an index not relevant to the “information element” into the association class. For example, referring to FIGS. 4 and 5, web pages 50 and 51 are classified into information on the node class. Among them, the web page 50 describes the “writer A” and the web page 51 describes the “writer B”. A web page 52-1 describing the “word X (name of program)” and a web page 52-2 describing a “word Y (name of actor)” are classified into the node class, and a web page 52-3 describing a “word Z (name of place)” is classified into the association class.

In the example illustrated in FIG. 4, the web page 52-1 has a link to refer the web page 50 and a link to refer the web page 51. In contrast, in the example illustrated in FIG. 5, the web pages 50 and 51 have respective links to refer to the web pages 52-1 through 52-3. In such a manner, each web page included in a set of information has reference relationship with each other.

The association node obtaining unit 31a calculates a degree of association between information elements corresponding respectively to two or more information items on the node class based on the reference relationship between the information on the node class and the information on the association class thus classified. The degree of association is calculated based on, for example, a number of reference counts. The number of reference counts is obtained by counting at least one of a number of referring the information on the association class from the information on the node class and a number of referring the information on the node class from the information on the association class for each information item in the set of information.

The reference from the node class to the association class is outbound (outward) reference when focusing on the information on the node class and is inbound (inward) reference when focusing on the information on the association class. The reference from the association class to the node class is inbound (inward) reference when focusing on the information on the node class and is outbound (outward) reference when focusing on the information on the association class. That is, the association node obtaining unit 31a determines another element corresponding to (associated with) one information element and the type of association (that is, perspective) indicating their joining by performing at least one of a first logic based on outward reference relationship as illustrated in FIG. 4 and a second logic based on inward reference relationship as illustrated in FIG. 5.

Then, based on the result of counting, the association node obtaining unit 31a calculates a degree of association between the information elements corresponding respectively to the two or more information items on the node class. In this case, depending on which one of the number of referring the information on the association class and the number of referring the information on the association class an emphasis is put on, each number of reference counts may be weighted. In the present embodiment, the degree of association between the information elements is calculated for each information item on the association class having reference relationship with the corresponding two or more information items on the node class. Accordingly, it is possible to consider that there is a plurality of types of association between one information element and another information element and a degree of association is calculated for each of the plurality of types of association. The type of association in this context is equivalent to a perspective of associating a concept represented by a certain information element with a concept represented by another information element.

(Association Node and Type of Association)

The association node obtaining unit 31a then obtains two or more information items on the node class (the first set of information corresponding to one information element and the second set of information corresponding to another information element) where there is common information on the association class (third set of information) based on the degree of association thus calculated.

For example, in the example illustrated in FIG. 4, it is determined that, with a first information element “writer A”, another information element “writer B” is associated from the perspective (type of association) “word X (program information)” by the first logic grounded in the outward reference relationship.

In the example illustrated in FIG. 5, it is determined that, with the first information element “writer A”, another information element “writer B” is associated from the perspective of the “word X (program information)”, the “word Y (name of actor)”, and the “word Z (name of place)” by the second logic grounded in the inward reference relationship.

(Unexpectedness)

The association node obtaining unit 31a also calculates a degree of unexpectedness (not to be widely recognized, low in profile/popularity) of each web page included in the set of information classified into the association class (information on the association class) in advance and stores the calculation result (unexpectedness score) in the storage unit 34.

Specifically, the association node obtaining unit 31a calculates unexpectedness based on reference counts from web pages included in the information on the node class to web pages included in the information on the association class (that is, a perspective page) (inward reference counts when focusing on the information on the association class). Fewer reference counts indicate higher unexpectedness (low in profile/popularity). The unexpectedness of each web page is calculated without considering the reference relationship with the set of information corresponding to the two or more nodes described above. Accordingly, in relationship with any node (information element of the information classified into the node class), the unexpectedness of each web page (perspective page) included in the information on the association class is in common.

Based on the calculated unexpectedness of each web page (perspective page), which type of association to be presented out of one or more types of association joining two or more nodes is determined by the screen control unit 31c described later. In other words, there may be one or more, respectively, of the type of association (perspective) determined based on the first logic based on the outward reference relationship described by referring to FIG. 4 and the type of association (perspective) determined based on the second logic based on the inward reference relationship described by referring to FIG. 5. The screen control unit 31c described later is thus capable of presenting a more unexpected perspective based on the unexpectedness of the web page from which the type of association is extracted.

Subsequently, a description is given to a specific method of calculating unexpectedness. For example, an unexpectedness score Score(L1) of a web page (perspective page, view) from which the type of association determined based on the first logic based on the outward reference relationship described by referring to FIG. 4 is extracted is obtained by a formula 1 below.

$$Score ( L 1 ) = α \times \frac{1}{log ( inlink ( v ) )} \qquad ( Formula 1 )$$

An unexpectedness score Score(L2) of a web page (perspective page, view) from which the type of association determined based on the second logic based on the inward reference relationship described by referring to FIG. 5 is extracted is obtained by a formula 2 below.

$$Score ( L 2 ) = β \times \frac{1}{log ( inlink ( v ) + 1 ) + 1} \qquad ( Formula 2 )$$

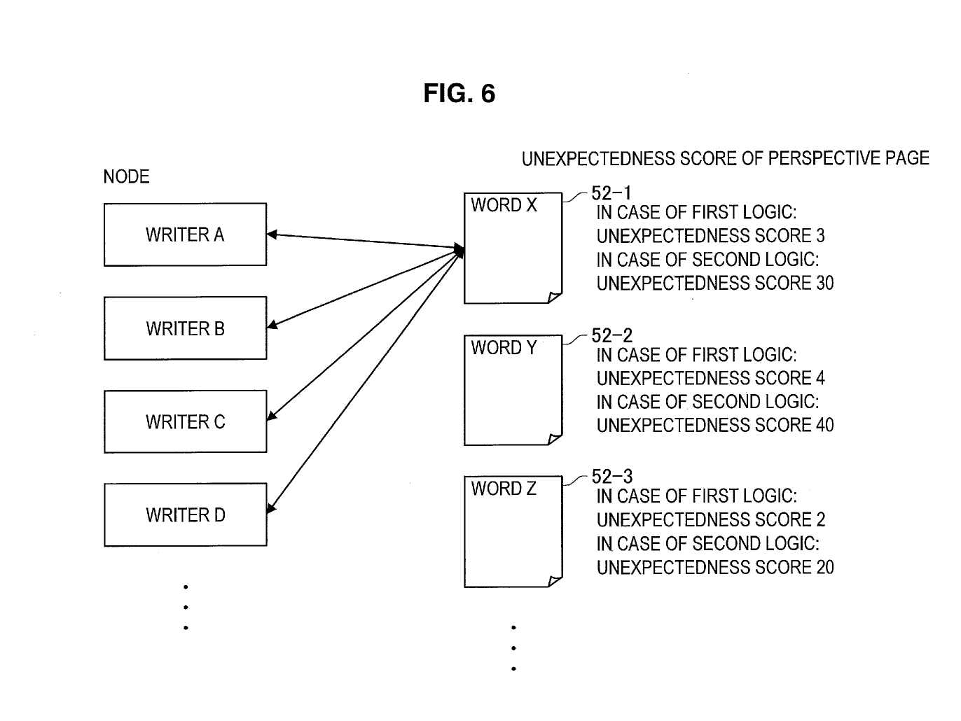

In the formulae 1 and 2, weight factors α and β are set in advance, when a plurality of perspectives are determined respectively by the first logic and the second logic and a perspective to be presented by the screen control unit 31c is determined from all the determined perspectives, depending on which perspective determined by the logic is important. With reference to FIG. 6, a description is given below to an example of calculating an unexpectedness score of each web page (perspective page) when the perspective determined by the second logic is more important.

FIG. 6 is a diagram illustrating an example of unexpectedness score calculation in each web page. As described above, association (reference relationship) with each node subject to presentation is not considered, so that the unexpectedness is in common as illustrated in FIG. 6 even when the unexpectedness of each web page is used as a web page from which a type of association indicating joining between any nodes of “writer A”, “writer B”, “writer C”, “writer D”, . . . is extracted.

The calculated unexpectedness becomes different when a different weight is given depending on which one of the first logic and the second logic determines the extracted type of association. For example, FIG. 6 illustrates that the unexpectedness score of the web page 52-1 from which the perspective “word X” is extracted is 3 when the “word X” is determined by the first logic and 30 when determined by the second logic. It also illustrates that the unexpectedness score of the web page 52-2 from which the perspective “word Y” is extracted is 4 when the “word X” is determined by the first logic and 40 when determined by the second logic. It also illustrates that the unexpectedness score of the web page 52-3 from which the perspective “word Z” is extracted is 2 when the “word X” is determined by the first logic and 20 when determined by the second logic.

The information processing apparatus 30 is thus capable of presenting a type of association of higher unexpectedness out of the plurality of types of association that are determined.

<2-2. Association Reason Extraction Unit>

The association reason extraction unit 31b extracts a description of a type of association between corresponding two or more nodes (one information element and another information element corresponding to it) from information on the association class (third set of information). The description of the type of association (that is, perspective) explains the perspective by a sentence and is, for example, a sentence including a word indicating the perspective or a summary of the sentence. In the present embodiment, it is possible to cause a user to sufficiently understand the joining of a plurality of associated nodes by extracting a sentence explaining the perspective in such a manner.

In addition to or instead a sentence explaining the perspective, the association reason extraction unit 31b may also present a sub- or semi-index including a sentence having a link to a node in the perspective page.

<2-3. Screen Control Unit>

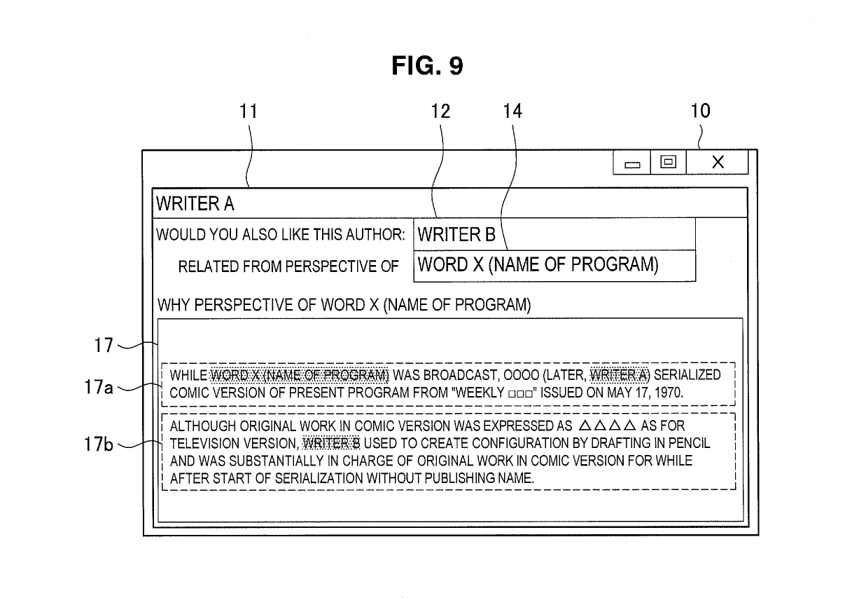

The screen control unit 31c (presentation control unit) controls the one information element, the other information element, the type of association (that is, perspective), and the description of the type of association (that is, reason explanation) to be presented to a user. Specifically, the screen control unit 31c generates an information element screen including the one information element, the other information element, the type of association, and the description of the type of association and controls the screen for sending from the communication unit 33 to the user terminal 20. The information element screen is described later with reference to FIGS. 9 through 11.

(Determination of Another Information Element to be Presented)

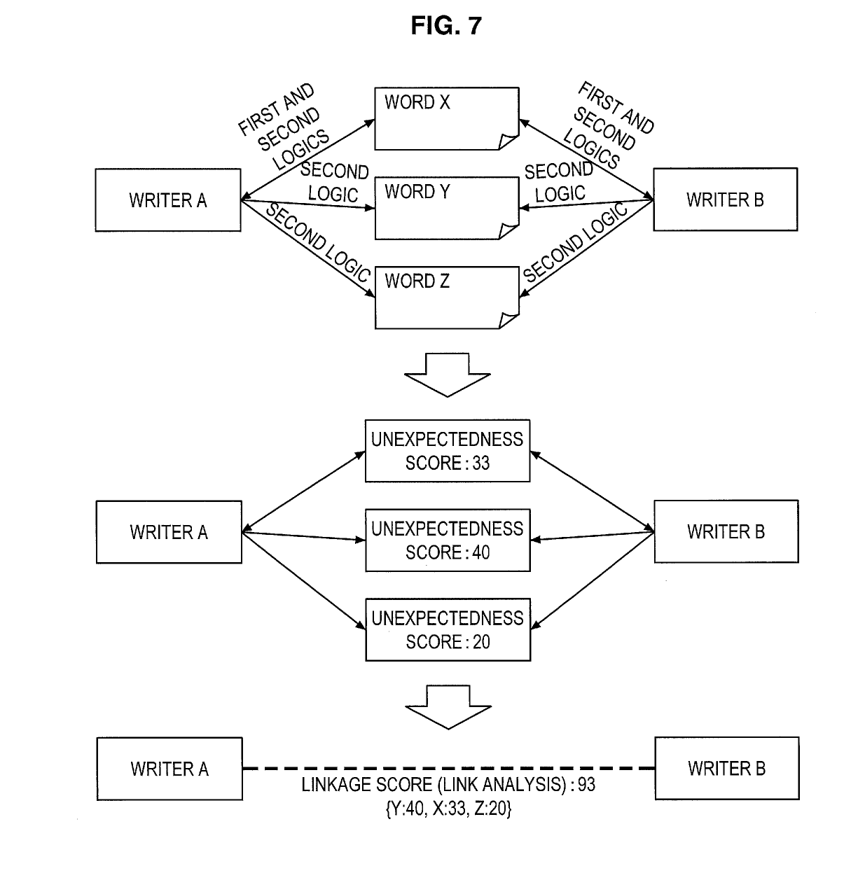

Here, the screen control unit 31c may determine another information element to be presented based on a sum of the respective unexpectedness of one or more types of association between one information element and one or more other information elements. A description is given below with reference to FIG. 7.

FIG. 7 is a diagram illustrating an example of a linkage score by link (reference relationship) analysis of each node. As illustrated in FIG. 7, it is assumed that there is, for example, a plurality of perspectives (types of association) “word X”, “word Y”, and “word Z” joining a node (one information element) “writer A” with a node (another information element) “writer B”. In this case, it is understood that a direction of reference is illustrated by an arrow connecting each node and the perspectives illustrated in FIG. 7, that is, the “word X” is a perspective extracted by any of the first and second logics and the “word Y” and the “word Z” are perspectives extracted by the second logic.

In this case, the unexpectedness score of the “word X” is calculated as 33, the unexpectedness score of the “word Y” as 40, and the unexpectedness score of the “word Z” as 20 as illustrated at the center of FIG. 7 in accordance with the example of the unexpectedness score illustrated in FIG. 6 by the association node obtaining unit 31a.

The screen control unit 31c then sums up the unexpectedness score of one or more perspectives joining each node and calculates the linkage score (link analysis version) of each node of 93 as illustrated in FIG. 7. By calculating such linkage score of each node respectively between one information element and one or more other information elements, the screen control unit 31c is capable of making a combination of a higher linkage score (that is, higher unexpectedness) of each node subject to presentation.

(Determination of Type of Association to be Presented)

The screen control unit 31c also determines a perspective to be presented (type of association) in accordance with the unexpectedness of the perspective (type of association). As described by referring to FIG. 6, when a plurality of the perspectives to join each node are extracted, the screen control unit 31c controls to present a perspective having a higher unexpectedness score in accordance with the unexpectedness score of each perspective calculated by the association node obtaining unit 31a. It is thus possible to present a more unexpected perspective to a user.

The screen control unit 31c may further determine the perspective to be presented based on user's preference information. For example, when an unexpected perspective is in a field (category) not interested by a user, the user is not interested in the linkage of the nodes and presentation of the information on the association node is not appropriate for the user. By determining the perspective to be presented taking the user's preference information obtained in advance into account, the screen control unit 31c is capable of presenting a perspective that is interested by the user and also unexpected.

(Determination of Description of Type of Association to be Presented)

The screen control unit 31c may also present a description of the type of association in a presentation form in accordance with the user's preference information. Specifically, the screen control unit 31c determines a form of perspective presentation (display form), such as presenting only by a word indicating the perspective, presenting in a state of extracting a sentence including the perspective from the perspective page, presenting a summary of the sentence, and presenting together with a sub- or semi-index of the perspective page in accordance with the user's preference.

(Others)

The one information element described above may be selected arbitrarily by a user and may also be selected automatically by the system.

### 3. CONFIGURATION EXAMPLE OF USER TERMINAL

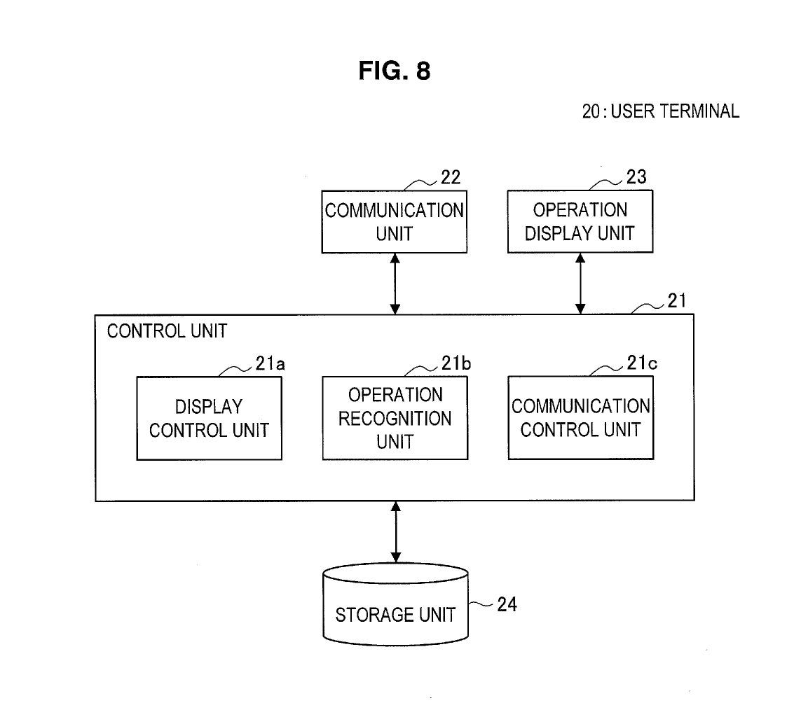

Next, a description is given to an example of a configuration of the user terminal 20 according to the present embodiment. FIG. 8 is a block diagram illustrating an example of a configuration of the user terminal 20. Referring to FIG. 8, the user terminal 20 is provided with a control unit 21, a communication unit 22, an operation display unit 23, and a storage unit 24.

(Control Unit)

The control unit 21 is configured by a microcomputer that is provided with, for example, a CPU, a ROM, a RAM, a non-volatile memory, and an interface unit, and controls each component of the user terminal 20. The control unit 21 according to the present embodiment also functions as a display control unit 21a, an operation recognition unit 21b, and a communication control unit 21c as illustrated in FIG. 8. The display control unit 21a controls so as to display an image on the operation display unit 23. For example, the display control unit 21a controls so as to display an information element screen sent back from the information processing apparatus 30. Here, a specific display example of the information element screen is described with reference to FIGS. 9 through 11.

(Information Element Screen)

FIG. 9 is a diagram illustrating a first display example of an information element screen 10. As illustrated in FIG. 9, the information element screen 10 includes a display area 11 to display one information element, a display area 12 to display another information element associated with the one information element, and a display area 14 to display a perspective (type of association) to join these information items. FIG. 9 illustrates that the writer A and the writer B are related from the perspective of the “word X (name of program)”.

Further, the information element screen 10 includes a display region 17 to carry out a reason explanation of the perspective. The display region 17 includes, for example, a reason explanation 17a to describe linkage between the perspective “word X” and one information element “writer A” and a reason explanation 17b to describe linkage between the perspective “word X” and another information element “writer B”. In such a manner, in the present embodiment, different from the comparative example illustrated in FIG. 2, it is possible to cause a user to more sufficiently understand the perspective by displaying the reason explanation of the perspective included in the information element screen 10.

Here, the one information element displayed on the display area 11 may also be inputted with an information element optionally selected by a user.

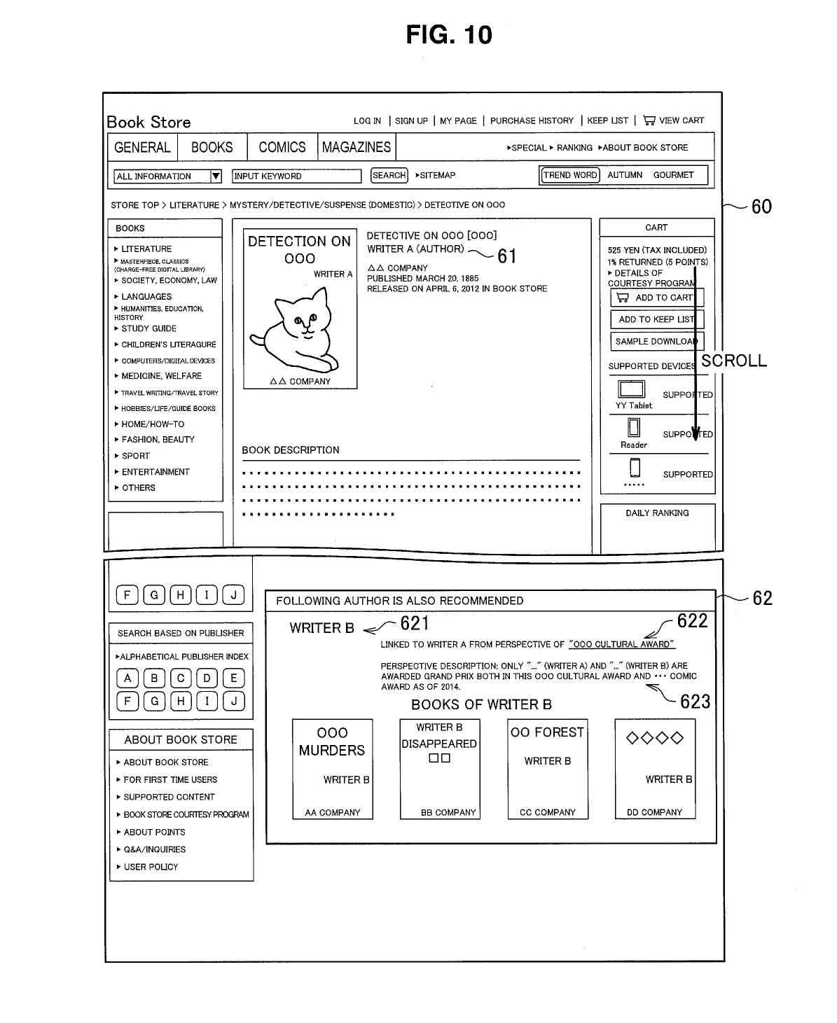

The information element screen according to the present embodiment is not limited to the example illustrated in FIG. 9. FIG. 10 is a diagram illustrating an example of an information element screen included in a book sales site.

As illustrated in FIG. 10, when a certain book is searched in a book sales site screen 60, a writer A 61 of the book is automatically selected by the system as one information element and an information element screen 62 is displayed where another information element associated with the one information element is presented together with the perspective and a reason explanation of the perspective.

In the information element screen 62 illustrated in FIG. 10, relationship 622 of a writer B 621 with the writer A from the perspective of “OOO cultural award” is presented together with a description reason 623 for the perspective.

In the perspective “OOO cultural award”, a link to transit to the perspective page (web page) may also be posted.

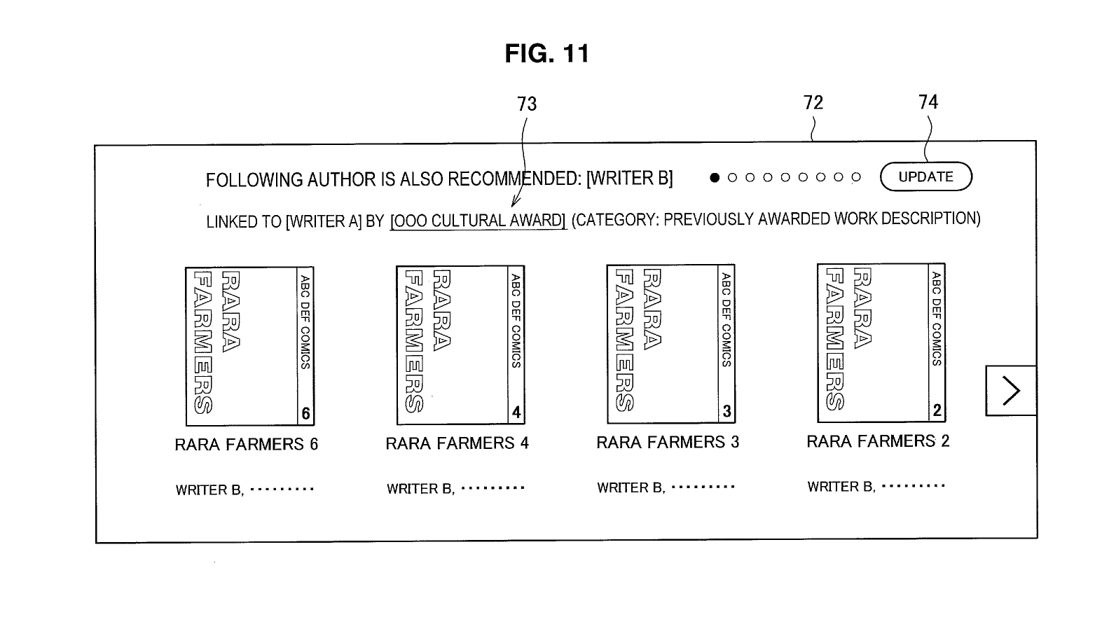

Subsequently, FIG. 11 illustrates an example of another information element screen 72 included in a book sales site. As illustrated in FIG. 11, an information element screen 72 includes display of the perspective “OOO cultural award” indicating linkage between the writer A and the writer B, a sub- or semi-index including the perspective in the perspective page, a “previously awarded work description” 73, an update button 74, and information (book information) on another information element “writer B”. In the perspective “OOO cultural award”, a link to the perspective page is posted.

In the example illustrated in FIG. 11, display of a sub- or semi-index “previously awarded work description” 73 in the perspective page of the link destination is displayed together. It may be thus recognized that there is linkage between the respective nodes “writer A” and “writer B” regarding previously awarded works in the perspective “OOO cultural award”.

The update button 74 is a button to update to another linkage author/linkage perspective. As described above, one having higher unexpectedness is presented among the linkage author (associated another information element)/linkage perspective to be presented on the information element screen 72, so that it is possible to sequentially display another linkage author/linkage perspective by tapping the update button 74.

The operation recognition unit 21b has a function of recognizing a user operation to the operation display unit 23. For example, the operation recognition unit 21b recognizes an input operation of one information element to the display area 11 of the information element screen 10.

The communication control unit 21c has a function of controlling communication with an external apparatus. For example, the communication control unit 21c controls one information element inputted to the display area 11 of the information element screen 10 to send to the information processing apparatus 30.

(Communication Unit)

The communication unit is connected to the communication network 40 and has a function to communicate with the information processing apparatus 30. For example, the communication unit 22 sends one information element selected by a user to the information processing apparatus 30 and receives an information element screen sent back from the information processing apparatus 30.

(Operation Display Unit)

The operation display unit 23 has functions of a display unit and an operation unit and may be achieved by, for example, a touch screen display. The function of a display unit is achieved by, for example, a liquid crystal display, an organic EL display, or the like and displays texts, images, and other information items on the display screen. The function of an operation unit is achieved by, for example, an operation surface that is superimposed on the display screen and detects a position of contact by a user.

(Storage Unit)

The storage unit 24 stores a program to perform various processes by the control unit 21 using a storage medium, such as a hard disk and a semiconductor memory.

### 4. OPERATION PROCESS

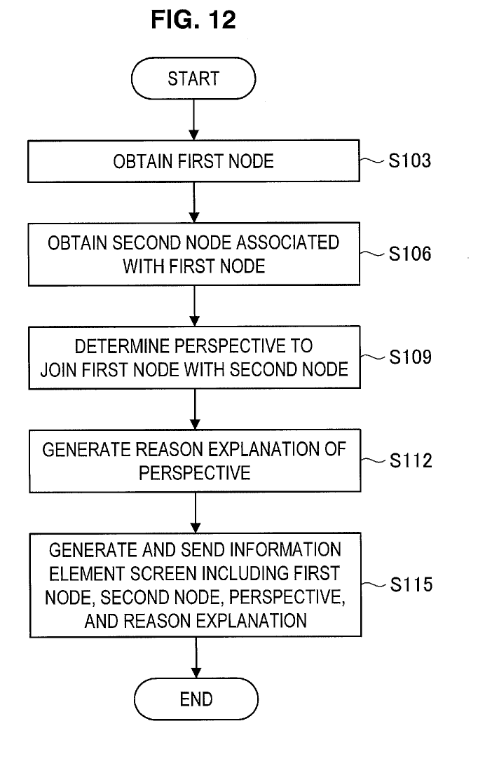

Subsequently, a description is given to operation process of the information processing system 1 with reference to FIG. 12. FIG. 12 is a sequence diagram illustrating operation process of the information processing apparatus 30 included in the information processing system 1 according to the present embodiment.

As illustrated in FIG. 12, firstly, in step S103, the association node obtaining unit 31a included in the control unit 31 of the information processing apparatus 30 obtains a first node (one information element). The first node (one information element) is selected arbitrarily by a user, for example.

Next, in step S106, the association node obtaining unit 31a obtains a second node (another information element) associated with the first node.

Then, in step S109, the association node obtaining unit 31a determines a perspective to join the first node with the second node. In this case, the association node obtaining unit 31a determines a perspective of high unexpectedness in accordance with unexpectedness of each perspective, for example.

Subsequently, in step S112, the association reason extraction unit 31b generates a reason explanation of the perspective (type of association) determined by the association node obtaining unit 31a.

In step S115, the screen control unit 31c then controls to generate an information element screen including the first node, the second node, the perspective, and the reason explanation and to send back to the user terminal 20.

The operation process of the information processing apparatus 30 according to the present embodiment has been described above specifically.

### 5. APPLICATION EXAMPLES

In the information processing system 1 described above, as described by referring to FIG. 7, the screen control unit 31c determines another information element to be presented in accordance with unexpectedness. Thus, another writer that is unexpected for a certain writer, for example, is presented.

Here, the information processing system 1 according to the present embodiment is capable of presenting another information element that is interested by a user and also high in unexpectedness by further integrating with, not only the unexpectedness, collaborative filtering (CF) using user preference information based on a history of actions in the past by a user. For example, although the writer B having linkage of high unexpectedness for the writer A is presented in the above embodiment, information (such as book information) on the writer B may not be appropriate for the user when the user is not so much interested in the writer B.

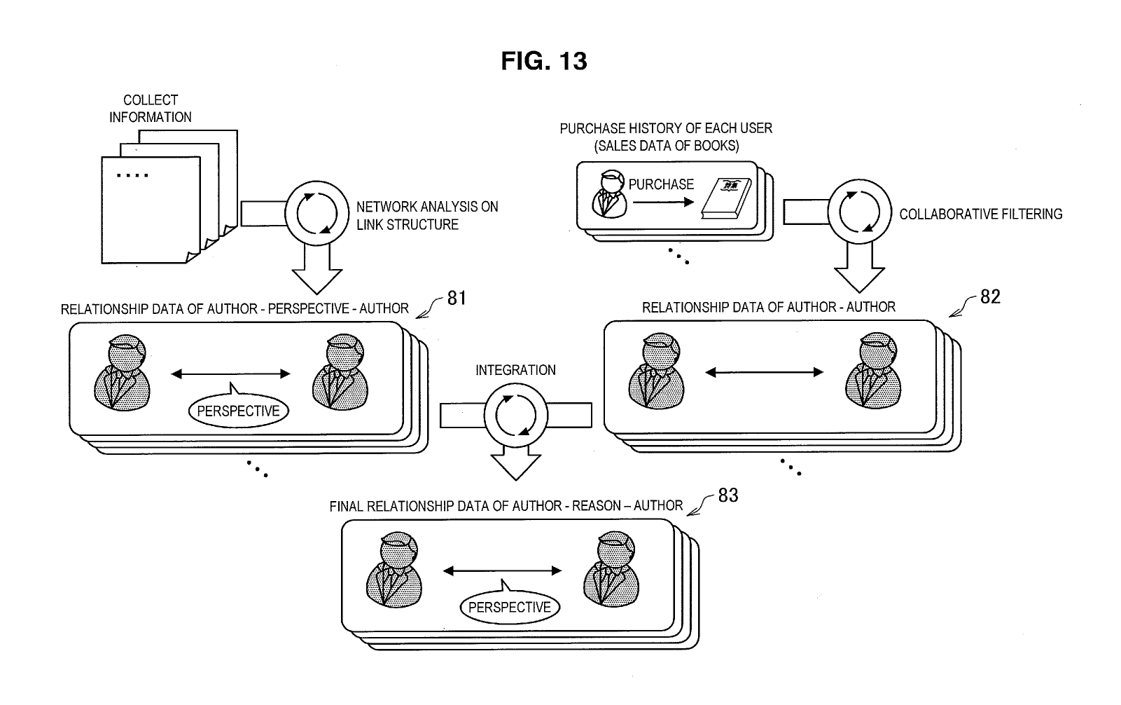

Accordingly, in the information processing system 1 according to the present embodiment, another information element to be presented is determined by further integrating with linkage between each information element obtained by using collaborative filtering in the screen control unit 31c included in the control unit 31 of the information processing apparatus 30. A description is given below with reference to FIGS. 13 through 15.

<Outline>

FIG. 13 is a diagram illustrating an outline of integration with collaborative filtering. As illustrated in FIG. 13, from a set of information including web pages, a linkage group of each node (data of relationship between two nodes via the perspective) obtained by network analysis of a link structure (reference relationship) and a linkage group 82 of each node obtained by using collaborative filtering generated based on actions in the past by each user, such as a purchase history of each user, are integrated. It is thus possible to obtain a final linkage group 83 of each node (data of relationship between two nodes via the perspective).

The linkage group 81 of each node (data of relationship between two nodes via the perspective) obtained by network analysis of a link structure (reference relationship) is obtained by the above embodiment (refer to FIG. 7), so that the description is omitted here.

<5-2. Linkage Between Nodes Obtained by Collaborative Filtering>

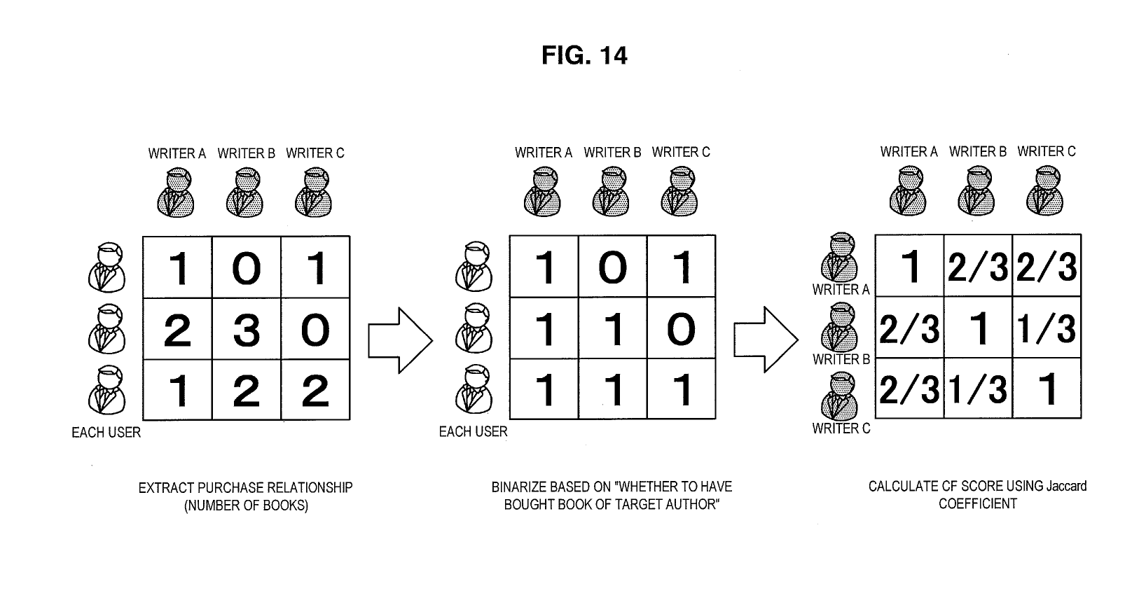

FIG. 14 is a diagram illustrating an outline of calculation of collaborative filtering. The example illustrated in FIG. 14 is an example of a calculation example of collaborative filtering (CF) on a basis of user's purchase. As illustrated on the left of FIG. 14, firstly, purchase relationship between each user (for example, all users that have purchased a book of each writer intended to calculate CF similarity) and each writer is extracted as a number of books bought by the user.

Next, as illustrated at the center of FIG. 14, the purchase relationship between each user and each writer is binarized based on whether or not each user has bought a book of the writer.

Then, as illustrated on the right of FIG. 14, a CF score between each writer (for example, writer A and writer A/writer B/writer C, writer B and writer A/writer B/writer C, writer C and writer A/writer B/writer C) are calculated using, for example, the Jaccard coefficient.

An example of CF calculation on a basis of user's purchase has been described above.

<5-3. Integration>

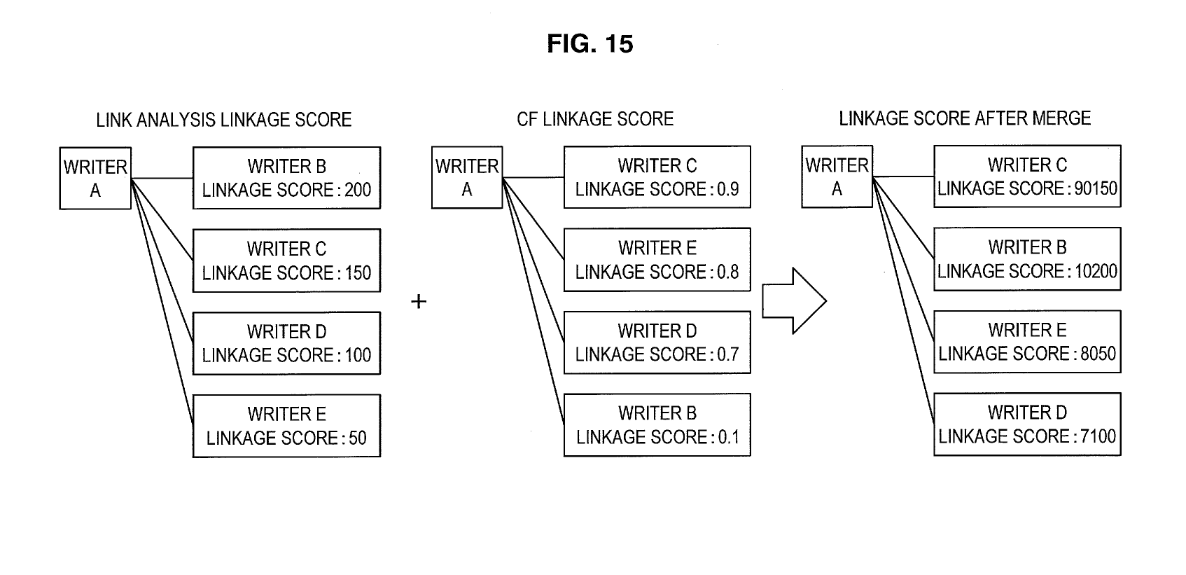

Subsequently, a description is given to integration of linkage of each node obtained by analysis of a link structure (hereinafter, may also be referred to as “a link analysis linkage score”) with linkage of each node obtained by utilizing the collaborative filtering (hereinafter, may also be referred to as “a CF linkage score”) with reference to FIG. 15.

FIG. 15 is a diagram illustrating integration of linkage of each node by link analysis with linkage of each node by collaborative filtering.

A link analysis linkage score illustrated on the left of FIG. 15 illustrates linkage scores (sum of unexpectedness scores of the perspective illustrated in FIG. 7) of a writer A with a writer B, a writer C, a writer D, and a writer E based on link analysis. Here, the linkage score with the writer B is highest.

Meanwhile, a CF linkage score illustrated at the center of FIG. 15 illustrates linkage scores of the writer A with the writer B, the writer C, the writer D, and the writer E based on collaborative filtering. The linkage score between each writer is calculated based on a purchase history of each user as described above, and is equivalent to, for example, CF similarity of the writer A with each of other writers whose books are purchased with interest by the user that has purchased a book of the writer A with interest. In the example illustrated in FIG. 15, the linkage score with the writer C is highest. Although the writers A through C are targeted in the example illustrated in FIG. 14, similar calculation is assumed to be performed on the writers D and E.

Then, on the right of FIG. 15, linkage scores after integration (after merge) are illustrated. The approach for integration may be considered variously and is obtained by, for example, formulae 3 and 4 below. In the formulae 3 and 4 below, each factor is set as “γ>>δ>>general linkage score”.

Linkage score (link analysis)+γ*linkage score (CF) (Formula 3)

(If linkage score (link analysis)>threshold)

γ=100000, threshold=120

Linkage score (link analysis)+δ*linkage score (CF) (Formula 4)

(otherwise)

δ=10000, threshold=120

Based on the formulae 3 and 4 above, a linkage score after integration is calculated as illustrated on the right of FIG. 15. Since the linkage score with the writer C is highest in this case, the screen control unit 31c is capable of presenting the writer B for a first candidate as another information element associated with the writer A. In such a manner, in the present application example, it is possible to present, not only unexpectedness based on link analysis, another information element interested by the user as an association node. Although the linkage scores between each writer calculated using collaborative filtering, as an example, are integrated in the present application example, the present disclosure is not limited to this example and it is possible to integrate the result of link analysis with a linkage score of each writer calculated by, other than collaborative filtering, an association recommendation mechanism, such as content based filtering, for example.

### 6. CONCLUSION

As described above, the information processing system according to an embodiment of the present disclosure is capable of causing a user to sufficiently understand joining of an information item with an information item by presenting a type of association, which is a variety of perspectives joining an information item with another information item, together with a reason explanation.

It should be understood by those skilled in the art that various modifications, combinations, sub-combinations and alterations may occur depending on design requirements and other factors insofar as they are within the scope of the appended claims or the equivalents thereof.

For example, it is also possible to create a computer program to exhibit functions of the information processing apparatus 30 and the user terminal 20 in hardware, such as a CPU, a ROM, and a RAM, built in the information processing apparatus 30 and the user terminal 20 described above. A computer readable storage medium having the computer program stored therein is also provided. Each function of the information processing apparatus 30 may also be loaded in the user terminal 20.

The perspective (type of association) to join a plurality of nodes (one information element and another information element) is not limited to text (keyword) and may also be images and sounds. The reason explanation of the perspective is not limited to a sentence and may also be an image and audio.

In addition, the effects described in the present specification are merely illustrative and demonstrative, and not limitative. In other words, the technology according to the present disclosure can exhibit other effects that are evident to those skilled in the art along with or instead of the effects based on the present specification.

Additionally, the present technology may also be configured as below.

(1) An information processing apparatus including:

an obtaining unit configured to obtain one or more other information elements corresponding to one information element based on a degree of association between the one information element and the other information elements;

an extraction unit configured to extract a description of a type of association between the one information element and the obtained other information elements; and

a presentation control unit configured to perform control in a manner that the one information element, the other information elements, the type of association, and the description of the type of association are presented.

(2) The information processing apparatus according to (1), wherein

the description of the type of association is a sentence including the type of association or a summary of the sentence.

(3) The information processing apparatus according to (1) or (2), wherein

the obtaining unit obtains the type of association from a third set of information in relationship to refer to a first set of information corresponding to the one information element and a second set of information corresponding to the other information elements.

(4) The information processing apparatus according to any one of (1) to (3), wherein

the obtaining unit obtains the type of association from a third set of information in relationship to be referred from a first set of information corresponding to the one information element and a second set of information corresponding to the other information elements.

(5) The information processing apparatus according to (3) or (4), wherein

the extraction unit extracts the description of the type of association from the third set of information.

(6) The information processing apparatus according to any one of (3) to (5), wherein

the obtaining unit calculates unexpectedness of the type of association based on a reference count from another set of information to the third set of information from which the type of association is extracted.

(7) The information processing apparatus according to (6), wherein

the presentation control unit determines a type of association to be presented in accordance with the unexpectedness.

(8) The information processing apparatus according to (7), wherein

the presentation control unit determines the type of association to be presented further based on user's preference information.

(9) The information processing apparatus according to any one of (5) to (8), wherein

the presentation control unit determines the other information elements to be presented based on a sum of respective unexpectedness of one or more types of association between the one information element and the one or more other information elements.

(10) The information processing apparatus according to (9), wherein

the presentation control unit determines the other information elements to be presented by further integration with linkage between respective information elements obtained by using collaborative filtering.

(11) The information processing apparatus according to any one of (1) to (10), wherein

the degree of association between the one information element and the other information elements is determined based on reference relationship of a first set of information corresponding to the one information element and a second set of information corresponding to the other information elements with a third set of information from which the type of association is extracted out of sets of information obtained from an information source accessible via a communication network.

(12) The information processing apparatus according to any one of (1) to (11), wherein

the presentation control unit presents the description of the type of association in a presentation form in accordance with user's preference information.

(13) The information processing apparatus according to any one of (1) to (12), wherein

the one information element is selected by a user.

(14) A control method including:

obtaining one or more other information elements corresponding to one information element based on a degree of association between the one information element and the other information elements;

extracting a description of a type of association between the one information element and the obtained other information elements; and

performing control in a manner that the one information element, the other information elements, the type of association, and the description of the type of association are presented.

(15) A program for causing a computer to function as:

an obtaining unit configured to obtain one or more other information elements corresponding to one information element based on a degree of association between the one information element and the other information elements;

an extraction unit configured to extract a description of a type of association between the one information element and the obtained other information elements; and

a presentation control unit configured to perform control in a manner that the one information element, the other information elements, the type of association, and the description of the type of association are presented.

What is claimed is:

1. An information processing apparatus comprising:
an obtaining unit configured to obtain one or more other information elements corresponding to one information element based on a degree of association between the one information element and the other information elements;
an extraction unit configured to extract a description of a type of association between the one information element and the obtained other information elements; and
a presentation control unit configured to perform control in a manner that the one information element, the other information elements, the type of association, and the description of the type of association are presented.

2. The information processing apparatus according to claim 1, wherein
the description of the type of association is a sentence including the type of association or a summary of the sentence.

3. The information processing apparatus according to claim 1, wherein
the obtaining unit obtains the type of association from a third set of information in relationship to refer to a first set of information corresponding to the one information element and a second set of information corresponding to the other information elements.

4. The information processing apparatus according to claim 1, wherein
the obtaining unit obtains the type of association from a third set of information in relationship to be referred from a first set of information corresponding to the one information element and a second set of information corresponding to the other information elements.

5. The information processing apparatus according to claim 3, wherein
the extraction unit extracts the description of the type of association from the third set of information.

6. The information processing apparatus according to claim 3, wherein
the obtaining unit calculates unexpectedness of the type of association based on a reference count from another set of information to the third set of information from which the type of association is extracted.

7. The information processing apparatus according to claim 6, wherein
the presentation control unit determines a type of association to be presented in accordance with the unexpectedness.

8. The information processing apparatus according to claim 7, wherein
the presentation control unit determines the type of association to be presented further based on user's preference information.

9. The information processing apparatus according to claim 5, wherein
the presentation control unit determines the other information elements to be presented based on a sum of respective unexpectedness of one or more types of association between the one information element and the one or more other information elements.

10. The information processing apparatus according to claim 9, wherein
the presentation control unit determines the other information elements to be presented by further integration with linkage between respective information elements obtained by using collaborative filtering.

11. The information processing apparatus according to claim 1, wherein
the degree of association between the one information element and the other information elements is determined based on reference relationship of a first set of information corresponding to the one information element and a second set of information corresponding to the other information elements with a third set of information from which the type of association is extracted out of sets of information obtained from an information source accessible via a communication network.

12. The information processing apparatus according to claim 1, wherein
the presentation control unit presents the description of the type of association in a presentation form in accordance with user's preference information.

13. The information processing apparatus according to claim 1, wherein
the one information element is selected by a user.

14. A control method comprising:
obtaining one or more other information elements corresponding to one information element based on a degree of association between the one information element and the other information elements;
extracting a description of a type of association between the one information element and the obtained other information elements; and
performing control in a manner that the one information element, the other information elements, the type of association, and the description of the type of association are presented.

15. A program for causing a computer to function as:
an obtaining unit configured to obtain one or more other information elements corresponding to one information element based on a degree of association between the one information element and the other information elements;
an extraction unit configured to extract a description of a type of association between the one information element and the obtained other information elements; and
a presentation control unit configured to perform control in a manner that the one information element, the other information elements, the type of association, and the description of the type of association are presented.
